(19) United States
(12) Patent Application Publication
(10) Pub. No.: US 2013/0053198 A1
(43) Pub. Date: Feb. 28, 2013

(54) Bicycle derailleur cover

(71) Applicant: Simon Smart, Brackley (GB)

(72) Inventor: Simon Smart, Brackley (GB)

(21) Appl. No.: 13/221,901

(22) Filed: Aug. 31, 2011

(51) Int. Cl. B62J 13/00

(52) U.S. Cl. 474/144

(57) ABSTRACT

Embodiments described herein provide for a derailleur cover with a housing and a mounting mechanism (for respectively covering and holding the housing in place around at least a portion of a chain-guide for the derailleur). Such derailleur cover not only provides for a shield or protection for the derailleur components, but another example embodiment also considers an airfoil shape of the housing for promoting non-turbulent airflow around the chain-guide.

### CROSS-REFERENCE TO RELATED APPLICATIONS

N/A

### BACKGROUND

Bicycle derailleur systems essentially provide a bicycle with a variable-ratio transmission system. Modern front and rear derailleurs include a moveable chain-guide, which switches a bicycle chain from various sizes cogs located on a wheel, crankset, or both. A rider operates shifters (typically mounted on a down tube, handlebar stem, or handlebar system), which then moves the chain-guide(s) from side to side, “derailing” the chain onto the desired cogs or sprockets.

Historically, derailleur systems used a Bowden cable attached to a lever or shifter for manually adjusting the chain-guides into the desired position. With modern advancements in electronic gear-shifting systems, now riders can shift with electronic switches instead of conventional control levers. The switches are connected by wire or wirelessly to a battery pack and to a small electric motor that drives the derailleur, switching the chain from cog to cog. Not only do these electronic systems allow for more precise chain and gear alignment, but they also switch gears faster, and because the system does not use Bowden cables and can calibrate itself, they typically require less maintenance.

Although the relatively new electronic derailleurs offer some added benefits, they are generally bulky in size and usually require mounting additional hardware (e.g., a battery, electronic components, etc.) to the bike. For non-competitive riders these drawbacks may seem insignificant; however, most any bicycle racer will agree that even small components cause atmospheric drag. As a rider moves faster, the induced atmospheric drag becomes greater, which intern requires the rider to expend greater energy to overcome it.

### BRIEF SUMMARY

Example embodiments of the present invention overcome the above-identified deficiencies and drawbacks of manual and electronic derailleur systems by providing a derailleur cover with a housing and a mounting mechanism (for respectively covering and holding the housing in place around at least a portion of a chain-guide for the derailleur). Such derailleur cover not only provides for a shield or protection for the derailleur components, but another example embodiment also considers an airfoil shape of the housing for promoting non-turbulent airflow around the chain-guide.

In another example embodiment, the derailleur cover described generally above further includes the added ability to cover at least part of other derailleur components and/or bicycle accessories. More specifically, these described embodiments provide for a hollow storage area in, and/or as an extension to, the housing, which covers at least portions of both the chain-guide and one or more bicycle components. Note that this embodiment can also take advantage of the added airfoil shape of the housing generally described in other embodiments above. As such, the housing provides for protection and/or an airfoil shape around at least portions of both the chain-guide and the added bicycle accessories. Thus, this later embodiment further promotes non-turbulent airflow around otherwise high drag components such as the faring, shroud, chain-guide or other derailleur components.

Note that this Summary simply introduces a selection of concepts in a simplified form that are further described below in the Detailed Description. Accordingly, this Summary does not necessarily identify key features or essential aspects of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a typical bicycle with a derailleur cover for a front chain-guide in accordance with example embodiments described herein;

FIGS. 2A and 2B respectively illustrate rear and forward facing views of a derailleur cover and corresponding chain-guide in accordance with example embodiments described herein;

FIGS. 3A-3C illustrate various views of a derailleur cover for a chain-guide partially extending therefrom and described in accordance with example embodiments herein;

FIGS. 4A-4C illustrate top, forward, and side views of a derailleur cover for a chain-guide in accordance with varying exemplary embodiments described herein; and

FIGS. 5A-5C illustrates top, rear, and side views of a derailleur cover for a chain-guide with various extensions in accordance with exemplary embodiments described herein.

### DETAILED DESCRIPTION

The present invention extends to methods, systems, and devices for a derailleur cover. More specifically, embodiments described herein provide for a derailleur cover with a housing and a mounting mechanism (for respectively covering and holding the housing in place around at least a portion of a chain-guide for the derailleur). Such derailleur cover not only provides for a shield or protection for the derailleur components, but another example embodiment also considers an airfoil shape of the housing for promoting non-turbulent airflow around the chain-guide.

Note that although the following descriptions and figures may make refer to the shape of the derailleur cover as either a general or specific airfoil shape, the specific shape of the derailleur cover may vary. Accordingly, the use of the airfoil shape used in the design and implementation of embodiments described herein is for illustrative purposes only and are not meant to limit or otherwise narrow the scope of the present invention unless otherwise explicitly claimed.

In another example embodiment, the derailleur cover generally described above may further include the added ability to cover at least part of other derailleur components and/or bicycle accessories. More specifically, these described embodiments provide for a hollow storage area in, and/or as an extension to, the housing, which covers at least portions of both the chain-guide and one or more bicycle components. Note that this embodiment can also take advantage of the added airfoil shape of the housing, generally described in other embodiments above and herein. As such, the housing provides for protection and/or an airfoil shape around at least portions of both the chain-guide and the added bicycle accessories. Thus, this later embodiment further promotes non-turbulent airflow around otherwise high drag components such as the faring, shroud, chain-guide, battery, electronic components, speed sensors, or other bicycle accessories.

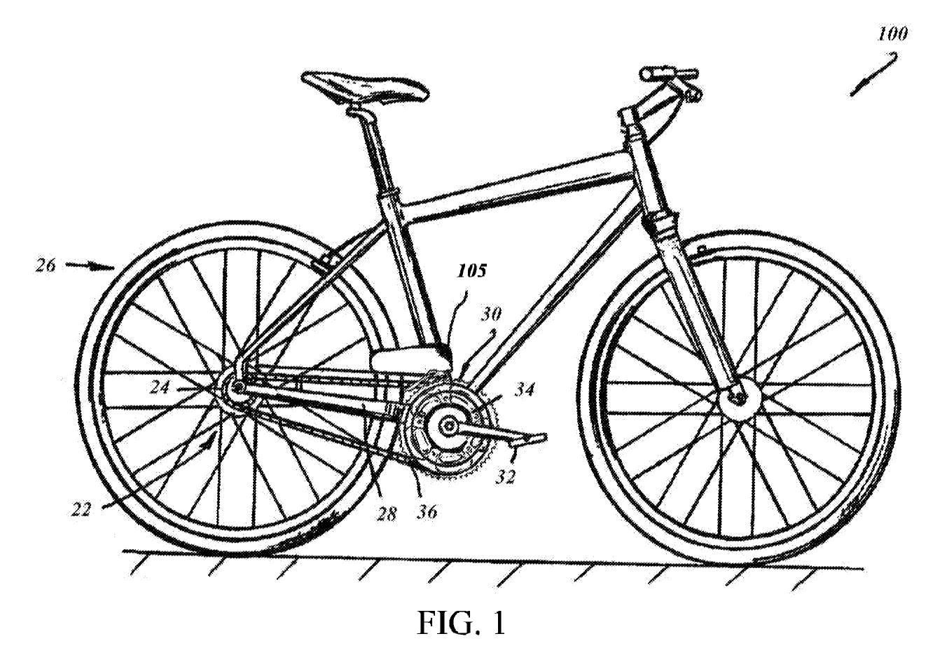

Referring now to the Figures, FIG. 1 illustrates a general bicycle 100 that can take advantage of one or more example embodiments described herein. For example, as shown, the bicycle 100 includes a derailleur system 22 with a front chain-guide for moving the bicycle chain 36 from one sprocket 30 to another. In other words, when a cyclist switches gears, the chain-guide moves the chain 36 between the sprockets or gears 30 on the crankshaft 34 as a cyclist peddles 32. Note that although FIG. 1 and the description thereof generally references and describes example embodiments in terms of the front derailleur chain-guide and system 22, embodiments described herein also generally apply to rear derailleur chain-guide, which assists in moving the chain 36 between sprockets or gears 24 around the rear hub. As such, the specific reference to the front derailleur chain-guide in describing example embodiments herein is used for illustrative purposes only and is not meat to limit or narrow the scope of the present invention; unless otherwise explicitly claimed.

As shown and generally referenced above, FIG. 1 further illustrates a derailleur cover 105, which includes a housing and mounting mechanism—as described in greater detail below. Note that in one example embodiment, the derailleur cover 105 provides a cover or shield that protects the derailleur chain-guide and/or other bicycle components or accessories. In other words, the derailleur cover 105 described herein generally shields or protects the derailleur components from influence by outside forces or systems, e.g., accidental impact, environmental elements (sun, rain, wind, dust, dirt, etc.), the cyclist and/or the cyclist's clothing, etc. Of course, there may be other advantageous reasons and ways to design the derailleur cover.

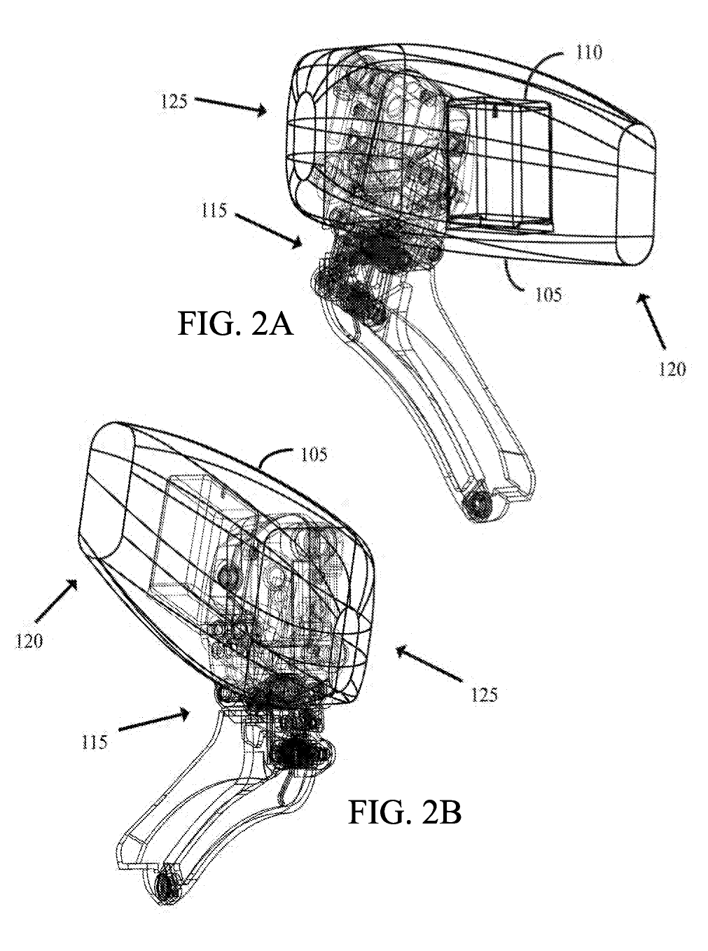

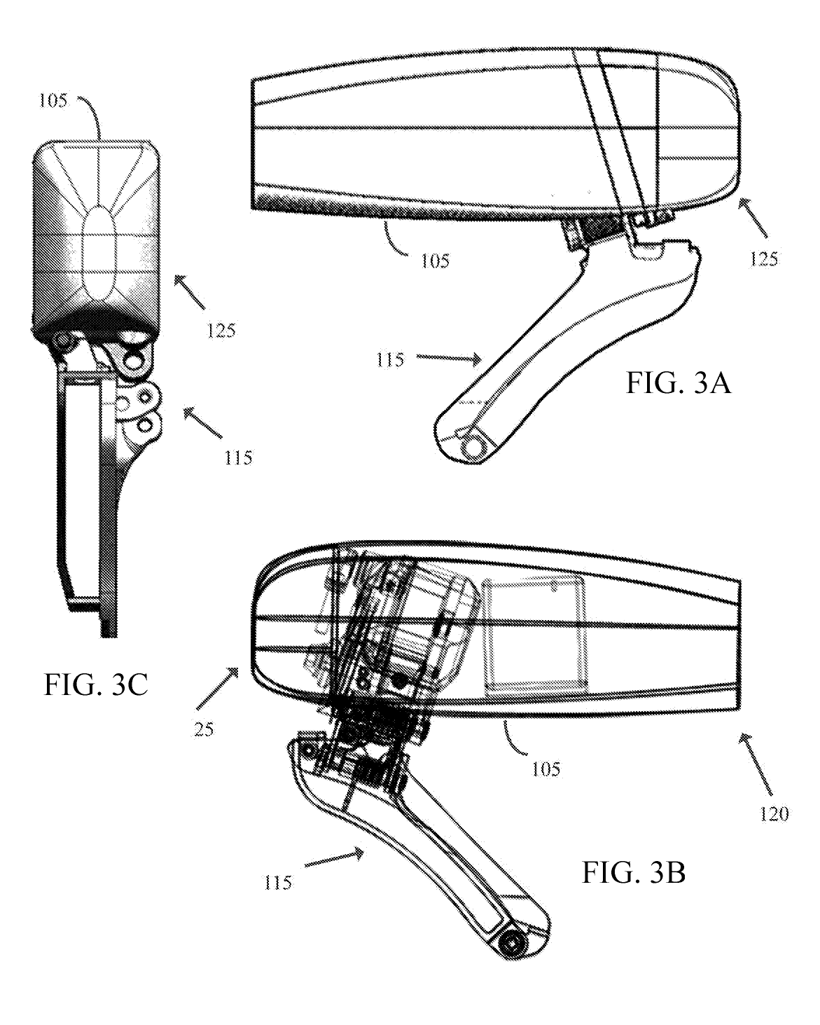

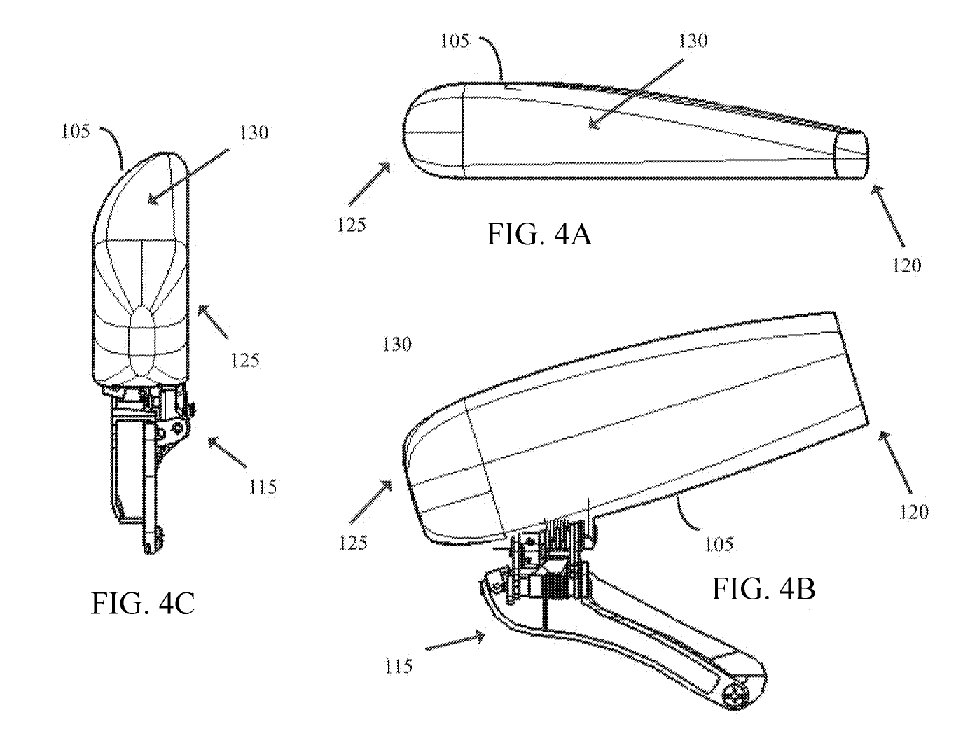

For example, other embodiments provide that the derailleur cover 105 is formed into an airfoil shape around the chain-guide 20. Note that such embodiment may further provide either a general or specific airfoil shape around the chain-guide 30. For example, as shown and generally referred to in FIGS. 2A-5C, embodiments provide a derailleur cover 105 with an added airfoil shaped body or housing, which provides for enhanced airflow around typically high drag components such as the faring, shroud, chain-guide or other derailleur components 115. In this embodiment, the airfoil shape will generally comprise a front section 125 that generally forms the leading edge of the airfoil and a back section 120 with sides that generally tapper away from the leading edge 125 to form a trailing edge of the airfoil shape.

More specifically, as shown in FIGS. 2A-4C, a front chain-guide 115 of a derailleur system includes a derailleur cover 105 with a housing designed in a general airfoil shape. Note that in this and other Figures described herein, the derailleur cover 105 is shown in skeleton form, e.g., as if designed with a supporting frame. Further note that the use of such skeleton or frame for illustrating the derailleur cover 105 is done for ease in making the derailleur cover 105 seem transparent. Nevertheless, it should be noted that the use of a frame or skeleton in designing and building example embodiments described herein is for illustrative purposes only and is not meant to limit or narrow the scope of the present invention unless explicitly claimed.

One advantageous feature of such embodiments is the ability to form a more aerodynamic airflow around the high drag derailleur components; yet still remain in compliance with UCI and other regulatory authorities. For example, the shape of the derailleur cover may be of a toroidal shape to form a substantially elliptical cross section. Generally, the forward facing part 125 of the derailleur cover 105 will form a somewhat narrow part of an ellipsis, gradually increasing in depth to a width diameter or distance and then tapering to form the trailing edge 120 of the airfoil shape.

As previously noted, example embodiments contemplate compliance with UCI and other regulatory standards. As such, example embodiments consider an aspect ratio (i.e., width to length diameter) of the derailleur cover 105 to range from about 2:1 to 6:1—and preferably about 3:1 or 3 in order to comply with UCI standards. As noted, however, the derailleur cover 105 may take on other aspect ratios and should not be limited to those noted above unless otherwise specifically claimed.

In other words, the aspect ratio of the width to length of the derailleur cover 105 may be non-UCI compliant (i.e., larger than 3:1 or 3). On the other hand, the aspect ratio of the derailleur cover (and any extensions thereto as described in other example embodiments) may preferably comply with UCI regulations, i.e., be less than about 3. Further, while not wishing to be bound by theory, it is believed that good aerodynamic efficiency is achieved with the derailleur cover 105 described herein, wherein countervailing aerodynamic factors of minimum frontal area and laminar or smooth airflow are balanced.

Of course, as previously mentioned, other example embodiments allow the bicycle derailleur cover to provide protection and aerodynamic airflow around other high drag bicycle components or accessories. For example, some of today's bicycles use electronic derailleur systems (e.g., Shimano's Di2), which utilize a battery or other power sources for operating electric motors or switches (in place of traditional lever-and-cable actuation) for moving the chain 36 from one sprocket 30 or gear to another. Although such electronic derailleurs can advantageously shift gears more rapidly, they have the added drawback of including additional high drag components, e.g., a needed battery power and electronic circuitry and switches. Accordingly, as generally shown in FIG. 2A, the derailleur cover 105 may include a hollow section or additional storage area 110 for shielding and/or providing an airfoil shape around other bicycle components or accessories (e.g., battery, electronics, speed sensor, etc.).

Note that the terms bicycle “components” and “accessories” are used herein to generally describe and make reference to various parts associated with a bike and it's inter-workings. Although reference may be made to a specific bike part as being associated with either a bicycle component or accessory, such reference should not be used to narrowly define these terms as being associated with any specific bicycle part. Moreover, these terms are used herein interchangeably; and therefore, any specific reference to a specific bicycle part as being either a “component” or an “accessory” is used herein for illustrative purposes only and is not meant to limit or narrow the scope of the present invention unless otherwise explicitly claimed.

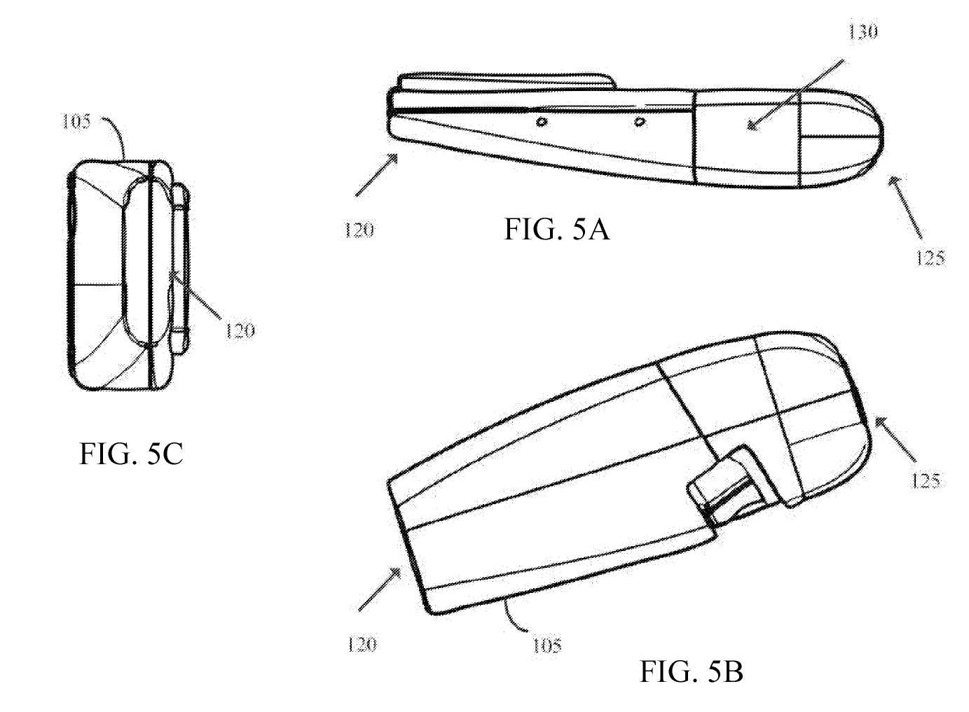

Note that although the above described added storage area 110 was formed within the derailleur cover 105, other example embodiments consider expanding portions of the derailleur cover 105 to provide the additional storage area for selected bicycle components. For example, as shown generally in FIGS. 5A-5C, one or more extensions 130 or expansion areas 135 may be added to the housing for providing the added storage area 110. Of course, there are many well-known mechanisms for providing such extensions 130 or expansion areas 135; and therefore, a more detailed description of how to form such extensions is omitted from the detailed specification.

Although not shown in great detail herein, the derailleur cover 105 includes a mounting mechanism, which attaches the cover 105 to the chain-guide 115 or other portion of the bicycle (e.g., the frame) for securing the cover 105 in place. Of course, such mounting mechanism may take on many forms including: a clamp for attaching the derailleur cover 105 to the frame of the bike; as part of a braze-on tab of the derailleur or bicycle frame; using a direct mount derailleur (DMD) system; or as a modification to an e-type attachment for a derailleur. Of course, other well-known attachment mechanisms can be used to attach the derailleur cover 105 in place; and therefore, any specific reference to an mounting mechanism used herein is for illustrative purposes only and is not meant to limit or otherwise narrow the scope of the present invention unless explicitly claimed.

Note that some embodiments form the housing as a single component. Other example embodiments, however, also provide for sectioning the housing 105 for ease in installation. For example, in one embodiment, the front section 125 forms a cap that can be used to hold in place two tapered sides that form the trailing edge 120. Such design allows the derailleur cover 105 to be placed around at least a portion of the chain-guide 115 without needing to take the derailleur apart. Of course, other ways of constructing the housing 105 by forming or fitting together multiple pieces is contemplated herein. As such, the above use of a cap and side pieces in designing or building the derailleur cover described herein is used for illustrative purposes only and is not meant to limit or narrow the scope of the present invention unless otherwise explicitly claimed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A bicycle derailleur cover comprising:
a housing that covers at least a portion of a chain-guide for the derailleur, which is used for moving a bicycle chain from one sprocket to another; and
a mounting mechanism for holding the housing in place around the at least a portion of the chain-guide.

2. The bicycle derailleur cover of claim 1, wherein the housing includes one or more of: (i) a hollow storage area for one or more bicycle components; or (ii) an airfoil shaped for promoting non-turbulent airflow around the chain-guide and the one or more bicycle accessories, if any.

3. The bicycle derailleur cover of claim 2, wherein the housing comprises multiple pieces that fit together to more easily cover the at least a portion of the chain-guide and the one or more bicycle accessories, if any.

4. The bicycle derailleur cover of claim 3, wherein the multiple pieces of the housing include:
a cap that forms a leading edge of the derailleur housing; and
one or more side sections coupled to the cap section that extend away therefrom to form to cover the at least a portion of the chain-guide.

5. The bicycle derailleur cover of claim 4, wherein the cap forms the leading edge of the airfoil shape and the one or more side sections form the sides of an airfoil shape, which generally make up the sides of a generally teardrop or airfoil shape.

6. The bicycle derailleur cover of claim 5, wherein the end cap forms a clamp around the one or more side sections, thereby securing them together and holding them rigidly in place around at least a portion of the chain-guide.

7. The bicycle derailleur cover of claim 5, wherein the one or more side sections further include one or more extensions, which provide additional storage area for one more bicycle components.

8. The bicycle derailleur cover of claim 5, wherein the housing further includes one or more side sections that are attached to, and extend away from, the cap section, wherein the one or more side sections tapper on an opposite end from the location of the cap to form a trialing edge of the airfoil shape.

9. The bicycle derailleur cover of claim 1, wherein the bicycle mounting mechanism allows the housing to cover the chain-guide near a crank-set of a bicycle.

10. The bicycle derailleur cover of claim 1, wherein the bicycle mounting mechanism allows the housing to also cover at least a portion of a battery.

11. The bicycle derailleur cover of claim 1, wherein the airfoil shape provides a 3:1 ratio of length to width around the chain-guide.

12. The bicycle derailleur cover of claim 1, wherein the housing attaches directly to the chain-guide.

13. The bicycle derailleur cover of claim 1, wherein the housing attaches directly to bicycle frame.

14. The bicycle derailleur cover of claim 2, wherein the hollow storage area is designed to store one or more bicycle components including a speed sensor, a battery, transponder, or electronic circuitry.

15. The bicycle derailleur cover of claim 14, wherein at least a portion of the hollow storage area includes one or more expansion pieces, which provided added storage capacity.

16. The bicycle derailleur cover of claim 15, wherein the one or more expensive pieces are designed for a specific bicycle component.
